(19) United States
(12) Patent Application Publication
(10) Pub. No.: US 2024/0246793 A1
(43) Pub. Date: Jul. 25, 2024

(54) ELEVATOR OPERATING DEVICE FOR AN ELEVATOR INSTALLATION WITH DESTINATION CALL CONTROL

(71) Applicant: Inventio AG, Hergiswil (CH)

(72) Inventor: Florian Trosch, Erlenbach ZH (CH)

(21) Appl. No.: 18/564,112

(22) PCT Filed: May 4, 2022
(86) PCT No.: PCT/EP2022/061903

§ 371 Date: Nov. 27, 2023

(30) Foreign Application Priority Data
May 31, 2021 (EP) 21176810.6

(51) Int. Cl. B66B 1/46

(52) U.S. Cl. CPC B66B 1/463; B66B 1/468; B66B 2201/4615; B66B 2201/463; B66B 2201/4653

(57) ABSTRACT

An elevator installation in a building includes an elevator control, an elevator car actuated by the elevator control to displace between floors of the building by a drive machine, and elevator operating devices arranged on the floors and connected to the elevator control. One of the elevator operating devices has a control device and a visual display unit, the control device receiving data for an optical code and a floor indicator from the elevator control to control the visual display unit according to the data for the optical code. The visual display unit displays the optical code in a display field. The control device controls the visual display unit to display a floor indicator in the display field, detect a touch of the optical code in the display field by a user and, upon a touch detection, generate an elevator call to a floor represented by the floor indicator.

### FIELD

The technology described here relates generally to an operating device for an elevator system and the operation thereof in a building. Exemplary embodiments of the technology relate in particular to an elevator system in which an elevator control allocates an elevator call input at an elevator operating device, and a method for operating such an elevator system.

### BACKGROUND

In buildings with elevator systems, elevator operating devices are arranged on the individual floors with which a user can call an elevator. In widespread elevator systems, an elevator operating device arranged on one floor has up/down buttons so that the user can input the desired direction of travel. In the elevator car, there is a car device in this elevator system so that the user can input the desired destination floor in the elevator car. In other known elevator systems, the user can already input the destination floor on an elevator operating device on the floor. For this purpose, the elevator system is equipped with a destination call control. For the input of the destination floor, an elevator operating device located on a floor has either an electromechanical keyboard, a touch-sensitive screen, an RFID card reader known from EP 0 699 617 B1, or a (Bluetooth) radio module known from EP 2 238 067 A1. For the operation of an elevator, it is known from EP 3 536 647 A1 to situate a matrix code (quick response, QR code) on a floor at or near an elevator. To input a call, a user can scan the QR code with a mobile phone/smartphone.

The mentioned possibilities for call input each have advantages and disadvantages; for example, a user must touch the electromechanical keyboard or the touch-sensitive screen, which may not be desirable in particular in times of a pandemic. The call input by means of an RFID card reader or mobile telephone requires in each case that the users handle an RFID card or a mobile telephone, which can in some circumstances be time-consuming and therefore also not desirable. There is therefore a need for a technology for call input in an elevator system that improves the operating comfort for a broader group of users who have different interests, without increasing the technical complexity of the elevator system.

### SUMMARY

One aspect relates to an elevator system that has an elevator control, an elevator car, which upon actuation by the elevator control can be moved from a first floor to a second floor by means of a drive machine, and a number of elevator operating devices arranged on floors of the building and connected to the elevator control. One of the elevator operating devices has a control device and a visual display unit, wherein the control device is configured to receive data for an optical code and data for a floor indicator from the elevator control, wherein the data for the optical code and the data for the floor indicator are stored in the elevator control as belonging to the same floor. The control device is also configured to control the visual display unit in accordance with the data for the optical code, wherein the visual display unit depicts the optical code in a first display field, and to control the visual display unit in accordance with the data for the floor indicator to depict the floor indicator in the first display field, wherein the floor indicator and the optical code are perceivable by the user. The control device is also configured to detect a touch of the optical code, depicted in the first display field, by the user and, upon detection of a touch, to generate an elevator call to a floor indicated by the floor indicator.

Another aspect relates to a method for operating an elevator system that has an elevator control, an elevator car, which upon actuation by the elevator control can be moved from a first floor to a second floor by means of a drive machine, and a number of elevator operating devices situated on floors of a building. The elevator operating devices are connected to the elevator control, wherein at least one of the elevator operating devices has a control device and a visual display unit. According to the method, the visual display unit is controlled to display an optical code and a floor indicator in a first display field, wherein the control takes place according to data received from the elevator control for the optical code and data received from the elevator control for the floor indicator. An electrical detection signal is generated by the visual display unit when the optical code shown in the first display field is touched by the user. If an electrical detection signal is present, an elevator call is generated, which is transmitted to the elevator control, wherein the elevator call indicates a floor displayed by the floor indicator.

The technology described here creates an elevator operating device which allows an elevator call to be input manually at an elevator operating device or with the aid of a communications device (e.g., a smartphone). The elevator operating device displays a display field and therein an optical code that can be detected and processed by the communications device. In addition to the optical code, the visual display unit shows a floor indicator in the display field, which visibly or readably indicates to the user which function and/or information is assigned to the display field or to the optical code. In particular, the floor indicator shows the user the floor that is assigned to the display field and can be input by the user as the destination floor. The elevator operating device is designed to recognize a touch of the display field, or the optical code shown therein, as an input of an elevator call. For example, a user carrying a mobile communications device can choose in which way the user wishes to input the elevator call. The choice can depend, for example, upon whether touching a surface of the elevator operating device is to be avoided for, for example, hygienic reasons, or whether the communications device is available (e.g., at hand and/or ready for use). If the call input is to take place as simply and quickly as possible, touching the elevator operating device with a finger can in some circumstances be done more quickly than handling the communications device, which may need first to be unlocked.

In one exemplary embodiment, the elevator operating device can display several display fields. The control device of the elevator operating device is designed to control the visual display unit to display at least a second display field. The first display field and the at least second display field are perceivable as spatially separated from one another by the user. As a result, the elevator operating device can be flexibly adapted to the building-specific requirements of the elevator system.

Due to the mentioned possibility of the type of call input (manually or with the aid of the communications device), a call confirmation or providing allocation information can take place flexibly at the elevator operating device or at the communications device. In one exemplary embodiment, the control device is configured to control the visual display unit to display an identifier of an elevator allocated to the elevator call in the first display field or a further shown display field. If the identifier is displayed in the first display field, it can be displayed instead of the optical code; the identifier is displayed for a defined period of time.

In addition to flexibility, the technology described here also offers security against misuse. In one exemplary embodiment, the elevator control is designed to generate data for a new optical code at regular or random intervals and to transmit it to the elevator operating devices. The control device controls the visual display unit according to the data for the new optical code, so that the new optical code is displayed in the first display field.

### DESCRIPTION OF THE DRAWINGS

Various aspects of the improved technology are described in greater detail below in conjunction with the drawings with reference to exemplary embodiments. In the figures, identical elements have identical reference signs. In the drawings:

FIG. 1 is a schematic representation of an exemplary situation in a building with multiple floors and of an exemplary elevator installation;

FIGS. 2A-2D show a schematic representation of an operation of an elevator operating device for an exemplary call input;

FIG. 3 is a schematic block diagram of an exemplary embodiment of an elevator operating device;

FIG. 4 is an exemplary representation of an exemplary embodiment of a method for operating an elevator operating device; and

FIG. 5 is an exemplary representation of an exemplary embodiment of a method for operating an elevator system having an elevator operating device that can be operated according to FIGS. 2A-2D.

### DETAILED DESCRIPTION

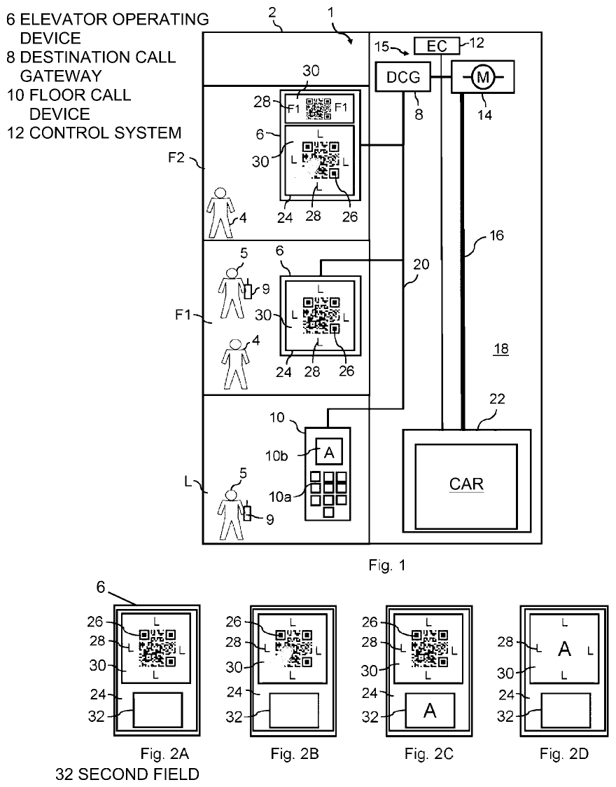

FIG. 1 is a schematic illustration of an exemplary situation in a building 2 which has several floors F1, F2, L which are served by an elevator system 1. In FIG. 1, for reasons of illustration, only selected components and subsystems of the elevator system 1 are shown: an elevator control 15 which is equipped with a destination call control, a drive machine 14, a suspension element 16 (e.g., steel cables or flat belts), an elevator car 22 (also designated car 22 in the following) suspended on the suspension element 16 and movable in a shaft 18, and devices (6, 10) for inputting elevator calls. The person skilled in the art recognizes that the elevator system 1 can also comprise several cars 22 in one or more shafts 18 which are controlled by a group control unit. Instead of a traction elevator (shown in FIG. 1), the elevator system 1 can also have one or more hydraulic elevators.

The elevator control unit 15 comprises in the exemplary embodiment shown in FIG. 1 two subsystems, a call allocation system 8, and a control system 12. The call allocation system 8 comprises a computer that allocates an elevator call to an elevator car 22 according to an allocation algorithm for servicing the elevator call. In one exemplary embodiment, the elevator call is a destination call, i.e., with the elevator call, the user 4, 5 informs the elevator control 15 of a desired destination floor; thus, indications of the boarding floor and the destination floor are present in the elevator control 15 before the user 4, 5 enters an elevator car 22. The call allocation can be done by the computer alone or in cooperation with the devices (6, 10) for inputting elevator calls of the elevator system 1. Such allocation algorithms are known to the person skilled in the art; an allocation algorithm in cooperation with call input devices is described, for example, in: Koehler, Jana, et al., An AI-Based Approach to Destination Control in Elevators, AI Magazine, Vol. 23, No. 3, 2002, pp. 59-78.

The call allocation system 8 also includes a device for sending and receiving signals via a communications network 20. Since the call allocation system 8 establishes a connection between components connected to the communications network 20 and the computer of the call allocation system 8, the call allocation system can also be referred to as a destination call gateway (DCG). The control system 12 controls the drive machine 14, among other things, such that the allocated car 22 is moved from the boarding floor to a destination floor. The person skilled in the art will recognize that the elevator control 15 can comprise further subsystems and components configured for different functions and tasks.

In the exemplary embodiment shown, at least one device (6, 10) is arranged on each floor L, F1, F2, by means of which device users 4, 5 can input elevator calls. In the following, the devices 6 on the floors F1, F2 are referred to as “elevator operating devices 6,” and the device 10 on the floor L is referred to as “floor call device 10.” The configuration of the devices (6, 10) is not limited to the configuration shown in FIG. 1; for example, a floor call device 10 may be arranged on one of the floors F1, F2, or an elevator operating device 6 may be arranged on the floor L. In addition, more than one of the devices (6, 10) can be arranged on one floor L, F1, F2. In one exemplary embodiment, the elevator operating devices 6 can be located on all floors L, F1, F2.

Each of the elevator operating devices 6 has a visual display unit 24 on which at least one display field 30 can be displayed in a manner perceivable or visible to the user 4, 5. In one exemplary embodiment, the visual display unit 24 is configured to recognize whether and where the user 4, 5 touches a user-facing surface of the visual display unit 24. Such a visual display unit 24 can also be referred to as a touch-sensitive visual display unit 24 or as a touch-sensitive screen (touchscreen). The functionality and structure of a touchscreen are generally known to the person skilled in the art.

In the situation illustrated in FIG. 1, the visual display unit 24 of the elevator operating device 6 on floor F1 displays a single display field 30, as an example, and the visual display unit 24 of the elevator operating device 6 on floor F2 displays two display fields 30, as an example. These display fields 30 each display an optical code 26 and a floor indicator 28. The optical code 26 and the floor indicator 28 form a pair, so to speak, wherein the floor indicator 28 is visible or readable to the user 4, 5 and indicates which function and/or information are assigned to the display field 30 or to the optical code 26. In FIG. 1, the function is, for example, a call input for a desired trip from the boarding floor F1, F2 to the floor L or from the boarding floor F2 to the floor F1.

The optical code 26 can be designed in various ways as long as it can be read and further processed by machine, using an optical reading device. In the exemplary embodiments described here, the optical reading device is a camera in a communications device 9 (e.g., mobile radio device/mobile telephone, smartphone, tablet PC). The optical code 26 may comprise, for example, an alphanumeric string and/or a representation of bars or dots of different widths and gaps between them, with the highest possible contrast. The aforementioned illustration can be a one-dimensional barcode or a two-dimensional (2-D) code. Examples of 2-D codes are 2-D barcodes (e.g., a coda block or a code 49) and matrix codes (e.g., a quick response (QR) code, a DataMatrix code, a JAB color code). Such codes and their generation are known to the person skilled in the art, so that further explanations do not appear to be necessary at this point.

In FIG. 1 and FIG. 2A—FIG. 2D, for example, a QR code is displayed in the display field 30 as the optical code 26, and the character “L” for the floor L is displayed as the floor indicator 28. In one exemplary embodiment, the elevator operating devices 6 on the floors F1, F2 can display different floor indicators 28, as shown in FIG. 1 on the floor F2. The person skilled in the art will recognize that the floor indicator 28 is not limited to one character (e.g., “L”), but can be realized in various ways as long as a user 4, 5 can read the floor indicator 28 and give it a meaning. Thus, the floor indicator 28 may include a number, one or more letters (text), an alphanumeric string, a symbol, a pictogram, or a combination of these options. The person skilled in the art will also recognize that, in another embodiment, the visual display unit 24 can display several display fields 30 with or without an optical code 26. If several optical codes 26 are displayed, they are to be arranged on the visual display 24 (for example, with sufficient spacing) such that they can each be read individually by a camera. The functions of the optical code 26 and the floor indicator 28 are explained elsewhere in this description.

The floor L can be an entrance hall of the building 2, which the users 4, 5 enter when entering building 2 and from which the users 4, 5 leave building 2 again. If a user 4, 5 enters the floor L, each floor F1, F2 of the building 2 can be reached with the elevator system 1 from there, with appropriate access authorization. An elevator operating device 6, a floor call device 10, or a combination of these devices (6, 10) can be located on the floor L. For illustration, in FIG. 1, only the floor call device 10 is located on the floor L.

The floor call device 10 is shown in FIG. 1 by way of example with a keyboard 10a and a display device 10b in order to indicate that a user 4, 5 on the floor L can input an elevator call (destination call) to any destination floor using the keyboard 10a, and that the user 4, 5 can be informed of the car 22 servicing the elevator call by means of the display device 10b. Alternatively to the keyboard 10a, a touch-sensitive screen (touchscreen), an RFID reader, a read or display device for an optical code (e.g., bar code, QR code, or color code), or a radio module that communicates with a portable communications device 9 of a user 5 can be used to enable the call input. The person skilled in the art recognizes that the user 4, 5 is informed of the car 22 operating the elevator call with these alternatives as well.

To illustrate and describe exemplary embodiments, in FIG. 1, two categories of users 4, 5 are shown. According to a first category, the users 5 can, for example, be people who live or work in the building 2; these users 5 each carry a mobile electronic communications device 9 (e.g., a mobile phone), which is configured, among other things, to operate the elevator system 1, as is described in more detail elsewhere in the present description. The users 5 are shown on floors F1 and L by way of example. According to a second category, the users 4 can, for example, be visitors who do not regularly stay in the building 2 and do not necessarily carry with them a communications device 9 which is configured to operate the elevator system. A user 4 may also be a person who lives in the building 2, but does not have his/her communications device 9 with him/her or is unable or unwilling to use it. In FIG. 1, the users 4 are shown without a communications device 9. The users 4 are shown on the floors F1, F2 by way of example.

In the situation shown in FIG. 1, the technology described herein can be used in an advantageous manner. Briefly and, by way of example, summarized, a user 4, 5 can enter an elevator call at an elevator operating device 6 according to the technology described herein by touching the display panel 30—in particular, by touching an optical code 26 displayed therein—or by reading the displayed optical code 26 using a communications device 9. For this purpose, the visual display unit 24 is controlled in such a way that, in addition to the optical code 26, the floor indicator 28 is displayed in the display field 30 and that a touch of the display field 30, wherein the illustrated optical code 26 can also be touched, is recognized as an input of an elevator call. The floor indicator 28 displays the destination floor assigned to the display field 30 to the user 4, 5. The user 4, 5 can thus choose in which way the user 4, 5 wishes to enter the elevator call. The choice can depend, for example, upon whether touching the visual display 24 is to be avoided for, for example, hygienic reasons, whether a communications device 9 is available (at hand and/or ready for use), or whether the call input is to take place as quickly as possible; in some circumstances, tapping the display field 30 with a finger can be done more quickly than handling the communications device 9, which may need to first be unlocked.

An exemplary operation of the elevator operating device 6 during a call input is shown in FIGS. 2A-2D. The elevator operating device 6 is designed such that its visual display unit 24 represents a further (second) field 32 in addition to the (first) display field 30. This field 32 may be configured, in accordance with the display field 30, as a display field that enables an input and a display, or as a display field that enables only a display. Here too, the person skilled in the art will recognize that the visual display unit 24 can display further fields. As explained above, the user 4, 5 can touch the display panel 30 shown in FIG. 2A or read in the displayed optical code 26 with a communications device 9. The display field 30 also indicates the destination floor (L) assigned to the optical code 26 (floor indicator 28). In FIG. 2B, it is indicated that the user 4, 5 touches the optical code 26 with a finger in order to input an elevator call for a trip request from the boarding floor to the destination floor (L). The call allocation system 8 allocates an elevator to the elevator call, and the allocated elevator is communicated to the user 4, 5. In FIG. 2C, the communication is done by displaying the allocated elevator (for example, elevator A) in field 32. The person skilled in the art will recognize that the elevator operating device 6 can additionally produce an acoustic notification. In an exemplary embodiment according to FIG. 2D, the visual display unit 24 can be controlled such that the allocated elevator is displayed in the display field 32 for a defined period of time (e.g., 1-2 seconds) instead of the optical code 26.

As an alternative to the touching shown in FIG. 2B, the user 5 can read in the optical code 26 with the communications device 9. The person skilled in the art will recognize that the communications device 9 can also be used on the floor L for reading in an optical code if the floor call device 10 there is displaying an optical code. The person skilled in the art will also recognize that the optical code 26 displayed on each floor L, F1, F2 is floor-specific, i.e., the elevator controller 15 stores which optical code 26 is displayed on which floor and on which floor call device 6, 10. As a result, the control device 8, 12 can recognize on which floor L, F1, F2 the call is entered. The optical code 26 can be temporally constant or variable (dynamic). A dynamic optical code can be changed at regular or random time intervals. This ensures (and prevents misuse) that the user 5 is directly at the respective call input device 6, 10 when inputting the call.

If the communications device 9 is, for example, a smartphone, application-specific software (also known as an “app”) can be installed thereon, which reads in and further processes the optical code 26. The communications device 9 communicates via a building-internal communications network and/or a mobile radio network with the elevator control 15, which receives the destination call including associated information about the boarding floor and destination floor, and initiates the allocation of an elevator. The person skilled in the art will recognize that, here as well, the allocated elevator is communicated to the user 5; the allocated elevator can, for example, be displayed on the visual display of the communications device 9 and/or transmitted as a voice message. An example of an app suitable for this application is the myPORT® app from the Schindler Group, Ebikon, Switzerland.

Depending upon the configuration of the elevator system 1 and/or the app, a user interface can be displayed on a visual display of the communications device 9, which user interface allows the operation of the elevator system 1 with the aid of the communications device 9. If the user 5 uses the communications device 9 to read the optical code 26, in one exemplary embodiment, the app can automatically generate a destination call to the destination floor displayed by the floor indicator 28. In another exemplary embodiment, the app can suggest the destination floor, displayed by the floor indicator 28, on the user interface as a destination floor, and provide the user 5 with the possibility of confirming the suggested destination floor or of selecting another destination floor within a defined period of time; if no selection is made within this time period, the call input can be aborted, or a destination call to the suggested destination floor can be automatically generated.

The floor indicators 28 (“L,” “F1”) shown in FIG. 1 can be fixedly assigned to the elevator operating devices 6; i.e., for a defined longer period of time, they display these floor indicators 28 unchanged. Such a fixed assignment can take place, for example, in connection with the installation of the elevator system 1 in the building 2. In one exemplary embodiment, the fixed assignment can be changed—for example, if the requirements and/or the use of the building 2 changes. In one exemplary embodiment, a floor indicator 28 on an elevator operating device 6 can be dynamically assigned, e.g., according to the current situation in the building 2 in general or only on one, or individual, floors F1, F2. If an event ends on a floor, for example, the elevator operating device 6 there can display the entry hall (floor L) as floor indicator 28 during this period; outside this period, another floor can be displayed as floor indicator 28—for example, a floor on which a restaurant is located. In an office building, the floor indicator 28 can display a restaurant floor, for example, at lunchtime and the entry hall at times during which the users 4, 5 are leaving the building 2. The person skilled in the art will recognize that the elevator control 15 controls the individual elevator operating devices 6 accordingly and stores the current assignment of the floor indicators 28.

The elevator operating devices 6 and the floor call device 10 are coupled to the elevator control 15 via a communications network 20. The network 20 is configured, for example, for an Ethernet connection to the elevator control 15. The communication between the elevator control 15 and the named devices 6, 10 takes place in accordance with a protocol for line-bound communication—for example, the Ethernet protocol.

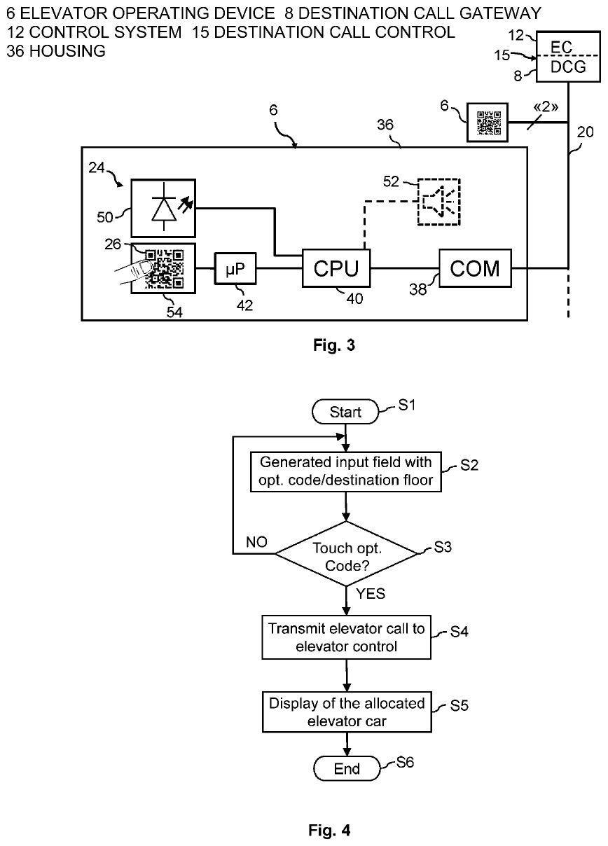

FIG. 3 shows a schematic block diagram of an exemplary embodiment of an elevator operating device 6, which is connected to the elevator control 15 via the communications network 20. FIG. 3 indicates that further elevator operating devices 6 are connected to the network 20. The visual display unit 24, a control device 40, 42, and a communications device 38 (COM) are arranged in a housing 36 of the elevator operating device 6. In the exemplary embodiment shown, the visual display unit 24 comprises an illumination device 50 and a display and input device 54. Depending upon the design of the elevator operating device 6, it can comprise an electro-acoustic transducer 52 (e.g., a loudspeaker) which is connected to the control device 40, 42; the electro-acoustic transducer 52 is shown in dashed lines as an optional component. The electro-acoustic transducer 52 can be used, for example, to output a voice message or an audible signal tone, e.g., to acoustically confirm an elevator call to the user 4, 5 or to announce the allocated elevator.

In the exemplary embodiment shown, the control device 40, 42 comprises a central processing unit (CPU) 40 and a processor 42, which are shown by way of example as separate components. The processor 42 is connected to the central processing unit 40 and the display and input device 54. The processor 42 detects, for example, a signal that is generated by the display and input device 54 when the user 4, 5 touches the surface of the visual display unit 24. The person skilled in the art will recognize that the central processing unit 40 and the processor 42, or their functions, can be combined in a control device (40, 42); accordingly, the function of the processor 42 can be performed by the central processing unit 40, and the illustration of the processor 42 can be omitted in FIG. 3. Controlled by the central processing unit 40, the display and input device 54 of the visual display unit 24 displays the optical code 26 in the display field 30 (the floor indicator 28 is not shown in FIG. 3).

The illumination device 50 is used to illuminate the user interface of the elevator operating device 6, or only regions of the user interface, e.g., the fields 30, 32. Controlled by the central processing unit 40, the illumination device 50 can illuminate the display device 54, or its user interface, with white light so that the displayed information can be perceived by a user 4, 5—in particular, in poor lighting conditions. The illumination device 50 can also illuminate the user interface fields 30, 32 with colored light in order to confirm the input of an elevator call to the user 4, 5. In one exemplary embodiment, the illumination device 50 comprises one or more LED light sources.

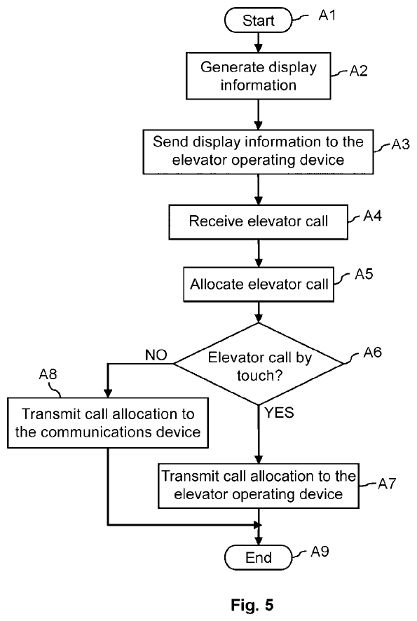

With the understanding of the above-described basic system components of the elevator system 1 and their functionalities, descriptions are given in the following of exemplary methods with reference to FIG. 4 and FIG. 5. Each of the methods is illustrated by means of an exemplary flowchart and steps carried out therein. The person skilled in the art will recognize that the division into these steps is by way of example, and that one or more of these steps may be divided into one or more substeps, or that several of the steps may be combined into one step. The description is made with reference to the users 4, 5, who are located for example on the floor F1 and from there (i.e., the boarding floor) call an elevator for a trip to a destination floor. Each elevator operating device 6 is activated and in communication with the elevator control 15.

A method for operating the elevator operating device 6 shown in FIG. 1 is shown in FIG. 4. The method begins with a step S1 and ends with a step S6.

In a step S2, a display field 30 is generated in which an optical code 26 and a floor indicator 28 are to be displayed. Since the elevator operating device 6 communicates with the elevator controller 15 via the communications device 38, the elevator operating device 6 receives from the elevator controller 15 information or data about the optical code, based upon which the optical code 26 is generated and displayed by the display device 24. The optical code 26 is floor-specific. In one exemplary embodiment, the elevator operating device 6 also receives information or data about the floor indicator 28.

In a step S3, the method waits for the optical code 26 or the display field 30 displaying it to be touched by the user 4, 5. If no touch takes place, the method remains in standby mode, which is indicated by a loop along the “no” branch back to step S2. If, on the other hand, a touch takes place, the method proceeds to step S4 along the “yes” branch.

In step S4, an elevator call is transmitted to the elevator control 15. The elevator call includes information about the boarding floor (F1) and the destination floor. The destination floor is the destination floor indicated by the floor indicator 28. The elevator operating device 6 transmits this information via the communications network 20 to the elevator control 15, which thereupon executes an allocation algorithm that allocates the elevator call to an elevator car 22. Allocation algorithms used are known to persons skilled in the art.

In a step S5, the elevator car 22 allocated to the elevator call is displayed by the display device 24. For this purpose, the elevator control 15 can, for example, send the allocation information relating to the elevator car 22 to the control device 40, 42. The control device 40, 42 controls the visual display unit 24 accordingly in order to display an elevator indicator (e.g., “A” in FIG. 2C and FIG. 2D) based upon the allocation information. The elevator indicator is displayed for a predetermined period of time—for example, for a few seconds (e.g., 1-2 seconds).

In one exemplary embodiment, the elevator indicator is displayed, from the perspective of the user 4, 5, almost simultaneously with the confirmation that the elevator call has been registered. This is possible because the call allocation takes place very quickly—for example, within milliseconds—using known allocation algorithms. In one exemplary embodiment, the confirmation of an elevator call is made by the display device 24. Alternatively or additionally, the confirmation can also take place acoustically—for example, using the electroacoustic transducer 52. Subsequently, the elevator operating device 6 again displays the optical code 26.

The operation of the elevator operating device for this elevator call ends according to step S6, shown in FIG. 4. The person skilled in the art recognizes that the elevator control 15 moves the elevator car 22 according to the elevator call after the call allocation, in order to transport the user 4, 5 to the desired destination floor.

In the following, on the basis of FIG. 5, an exemplary method is described for operating the elevator system 1 shown in FIG. 1 with the elevator operating devices 6 shown there. The method begins with a step A1 and ends with a step A9.

In a step A2, display information is generated. The display information is generated by the elevator control 15 and includes data, to be encoded in the optical code 26, that an elevator operating device 6 has to display in floor-specific fashion. This data can include, for example, an address (e.g., URL) of the elevator system 1, so that the app in the communications device 9 can communicate with the elevator system 1. The display information also includes data indicating the floor indicator 28 that the elevator operating device 6 also has to display; in one exemplary embodiment, the floor indicator 28 can likewise be floor-specific. In addition, the display information includes an identifier (number) of the display information. This display information is stored in a memory device of the elevator control 15; there, it is thus stored which display information identifiable by the identifier is sent to a specific elevator operating device 6 at which time.

In a step A3, the display information is sent from the elevator control 15 to the elevator operating device 6. Based upon this display information, the elevator operating device 6 displays the optical code 26 and the floor indicator 28. Exemplary representations of the optical code 26 and the floor indicator 28 are shown in FIG. 1 and FIG. 2A.

In a step A4, an elevator call is received. If the elevator controller 15 receives the elevator call, the communications channel over which the elevator call is received is also detected. If the user 4, 5 enters the elevator call at the elevator operating device 6 by touching the display field 30, the communications channel includes the communications network 20. However, if the user 5 uses the communications device 9, the communications channel includes an app interface and/or a radio interface.

In a step A5, the received elevator call is allocated to an elevator car 22, and allocation information is generated. As explained above, an allocation algorithm is used for the call allocation.

In a step A6, it is determined whether the allocation information is to be transmitted to the elevator operating device 6 or to the communications device 9. In the exemplary embodiment shown, in step A6, it is checked whether the elevator call was made by touching the surface of the visual display unit 24, and therefore the elevator call was transmitted via the communications network 20 from the relevant elevator operating device 6. If this is the case, the method moves along the “yes” branch to a step A7 in which the allocation information is transmitted via the communications network 20 to the elevator operating device 6 (cf. step S5 in FIG. 4).

If, on the other hand, the user 5 uses the communications device 9 to read the optical code 26, the elevator call is received via the app interface. In step A6, therefore, the check indicates that the elevator call was not generated by touching an elevator operating device 6, and the method advances along the “no” branch to a step A8 in which allocation information is transmitted to the user's communications device 9 via the app interface. The method ends with step A9.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. An elevator system including a destination call control by which a user on a floor of a building inputs a destination floor, the elevator system comprising:
an elevator control;
an elevator car movable by a drive machine between floors of the building upon actuation by the elevator control;
a plurality of elevator operating devices arranged on the floors of the building and connected to communicate with the elevator control, wherein one of the elevator operating devices includes a control device and a visual display unit;
wherein the control device receives data for an optical code and data for a floor indicator from the elevator control, the data for the optical code and the data for the floor indicator being stored in the elevator control as belonging to a same one of the floors;
wherein the control device controls the visual display unit, according to the data for the optical code, to display an optical code representing the one floor in a first display field;
wherein the control device controls the visual display unit, according to the data for the floor indicator, to display a floor indicator representing the one floor in the first display field, the floor indicator and the optical code displayed being perceivable by the user;
wherein the control device detects a touch by the user in the first display field at the displayed optical code; and
wherein the control device responds to the detected touch by generating an elevator call to the one floor represented by the floor indicator.

11. The elevator system according to claim 10 wherein the control device controls the visual display unit to display in a second display field, wherein the first display field and the second display field are perceivable by the user as spatially separated from one another.

12. The elevator system according to claim 10 wherein the control device controls the visual display unit to display an identifier of an elevator allocated to the elevator call in the first display field or in a second display field of the visual display unit.

13. The elevator system according to claim 10 wherein the control device controls the visual display unit to display an identifier of an elevator allocated to the elevator call in the first display field instead of displaying the optical code.

14. The elevator system according to claim 10 wherein the elevator control generates data for a new optical code at regular time intervals or at random time intervals and transmits the new optical code to the elevator operating devices, wherein the control device controls the visual display unit according to the data for the new optical code to display the new optical code in the first display field.

15. The elevator system according to claim 10 wherein the visual display unit is a touch-sensitive visual display unit.

16. A method for operating the elevator system according to claim 10, the method comprising the steps of:
controlling the visual display unit to display the optical code and the floor indicator in the first display field according to the data received from the elevator control for the optical code and data received from the elevator control for the floor indicator;
generating an electrical detection signal by the visual display unit when the optical code displayed in the first display field is touched by the user; and
when the electrical detection signal is generated, generating an elevator call and transmitting the elevator call to the elevator control, wherein the elevator call indicates the floor shown by the floor indicator displayed in the first display field.

17. The method according to claim 16 including controlling the visual display unit to display a second display field, wherein the first display field and the second display field are perceivable by the user as spatially separated from one another.

18. The method according to claim 16 including controlling the visual display unit to display in the first display field or in a second display field an identifier of an elevator allocated to the elevator call.

19. The method according to claim 16 wherein the elevator call is a destination call to which a boarding floor and a destination floor are assigned.
